(19) United States
(12) Patent Application Publication
(10) Pub. No.: US 2013/0275893 A1
(43) Pub. Date: Oct. 17, 2013

(54) SCREEN CREATION SYSTEM FOR PROGRAMMABLE DISPLAY

(71) Applicants: Yoshihisa Kawamura, Tokyo (JP); Masaru Nakamura, Tokyo (JP)

(72) Inventors: Yoshihisa Kawamura, Tokyo (JP); Masaru Nakamura, Tokyo (JP)

(73) Assignee: MITSUBISHI ELECTRIC CORPORATION, Chiyoda-ku, Tokyo (JP)

(21) Appl. No.: 13/996,794

(22) PCT Filed: Dec. 24, 2010
(86) PCT No.: PCT/JP2010/073307

§ 371 Date: Jun. 21, 2013

(51) Int. Cl. G06F 3/0481

(52) U.S. Cl. CPC G06F 3/0481
USPC 715/763

(57) ABSTRACT

A screen creation system for creating a screen to be displayed at a graphical user interface of a programmable display includes: a registering unit that registers setting items that are set as a template regarding a configuration of a plurality of parts that makes the screen as elements that constitute the screen. When a new registration of the template is instructed regarding parts that are selected from the graphical user interface, the registering unit for registering the template is configured to: group and present setting items for each one of the selected parts based on properties thereof; and accept selection of the setting items to be included in the template.

### FIELD

The present invention relates to a screen creation system for a programmable display.

### BACKGROUND

In a case of creating a user original screen to be displayed on a programmable display, a user arranges a plurality of parts on a graphical user interface (GUI) of a screen creation system, and sets setting items constituting each of these parts respectively. Furthermore, the user sets setting items such as screen-data common settings and scripts respectively. At this time, the user can create the screen easily and readily by reusing already created screen data into which a plurality of parts, screen-data common settings, scripts, and the like are incorporated.

### CITATION LIST

### Patent Literatures

Patent Literature 1: Japanese Patent Application Laid-open No. 2003-186671

Patent Literature 2: Japanese Patent Application Laid-open No. 2006-99566

### SUMMARY

### Technical Problem

According to a conventional technique, in a case where the parts, the screen-data common settings, the scripts, and the like for the screen data to be reused are edited, the parts or the setting items are selected one by one and the settings are confirmed and changed. In a case of changing the setting items by batch conversion, it is often necessary to input complicated conditions for narrowing down the setting items.

Furthermore, to obtain the screen data to be reused, it often requires a user to perform operations such as opening the screen data one by one from a large-scale database held in a personal computer, a server, or the like. In this way, the conventional technique has a problem that it takes much time and effort at editing or reusing the screen data.

The present invention has been made in view of the above problems, and an object of the present invention is to provide a screen creation system for a programmable display capable of improving working efficiency at the time of editing or reusing screen data.

### Solution to Problem

To solve the above problems and achieve the object; a screen creation system for a programmable display for creating a screen to be displayed on the programmable display by arranging parts on a graphical user interface includes; a unit that accepts selection of setting items constituting each of a plurality of parts so as to register the parts and the setting items as a template on the graphical user interface.

### Advantageous Effects of Invention

The screen creation system for a programmable display according to the present invention can display and edit settings of a plurality of parts, screen-data common settings, scripts, and the like as one list, and efficiently edit or reuse the screen data. Furthermore, it is no longer necessary to search desired screen data from a database that stores a large volume of screen data This can reduce man-hours at the time of using the screen data.

### BRIEF DESCRIPTION OF DRAWINGS

FIG. 1 depicts an image of a screen created by a screen creation system for a programmable display according to an embodiment of the present invention.

FIG. 2 is an example of a property registration window of a template.

FIG. 3 is an example of a property window of a registered template.

FIG. 4 is an explanatory diagram for highlighting a part on a screen.

FIG. 5 is an explanatory diagram for changing set values by batch conversion in a case where a same set value is set to grouped setting items.

FIG. 6 is an explanatory diagram for changing set values by batch conversion in a case where a same set value is set to grouped setting items.

FIG. 7 is an explanatory diagram for changing set values by batch conversion in a case of holding regularity of the set values.

FIG. 8 is an explanatory diagram for changing set values by batch conversion in a case of holding regularity of the set values.

FIG. 9 is an explanatory diagram in a case for changing set values individually.

FIG. 10 is an explanatory diagram in a case for changing set values individually.

FIG. 11 is an explanatory diagram for registration of a template to a library.

FIG. 12 is an example of a library window.

### DESCRIPTION OF EMBODIMENTS

Exemplary embodiments of a screen creation system for a programmable display according to the present invention will be explained below in detail with reference to the accompanying drawings. The present invention is not limited to the embodiments.

### Embodiment

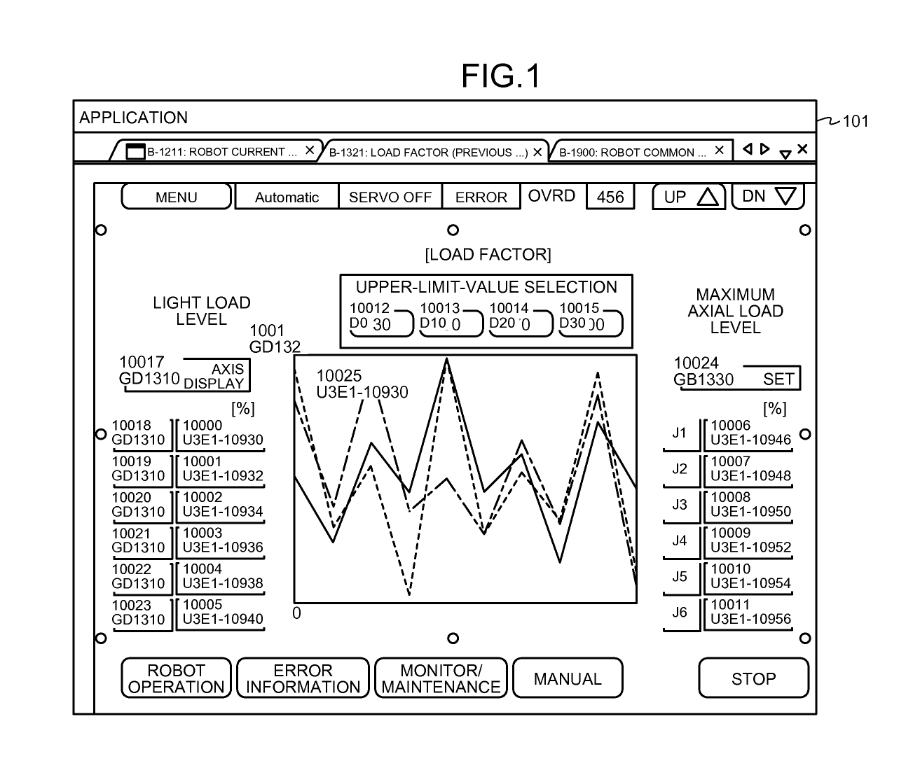

FIG. 1 depicts an image of a screen created by a screen creation system for a programmable display according to an embodiment of the present invention. A screen 101 displayed on the programmable display can be created using the screen creation system that is software installed into a personal computer or the like. The screen 101 created by the screen creation system is transferred to the programmable display and stored therein as screen data.

A user arranges parts on a GUI of the screen creation system and the parts constitute the desired screen 101. In the present embodiment, the parts are such images as switches, numerical display of meters, title characters, and graphs, and are defined as elements that can be arranged and combined on the screen 101 similarly to parts constituting objects.

A user selects a plurality of parts on a tool bar and the GUI, and newly registers the selected parts as a template by operating a context menu, a shortcut key, or the like.

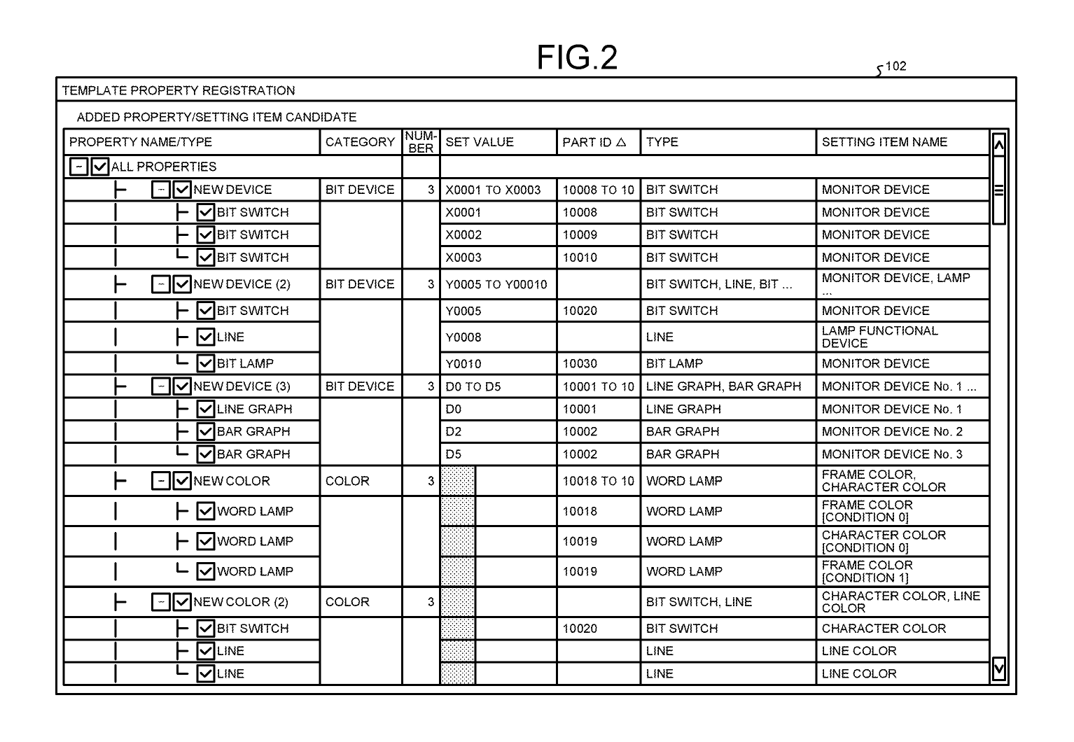

FIG. 2 is an example of a property registration window of a template. The screen creation system displays a property registration window 102 on the GUI at the time of newly registering the template. Setting item candidates to be added to the newly registered template are displayed on the property registration window 102.

The property registration window 102 is defined as a means for accepting selection of the setting items so as to register a plurality of parts and setting items constituting each of the parts as a template. The user selects and registers arbitrary setting items of each part by, for example, checking each checkbox displayed in a “property name/type” field.

The screen creation system automatically discriminates the same or similar setting items from among those of each part, sets the discriminated setting items as candidates of grouped setting items, and displays the grouped setting items in the property registration window 102. The screen creation system can also register the grouped setting items as one setting item.

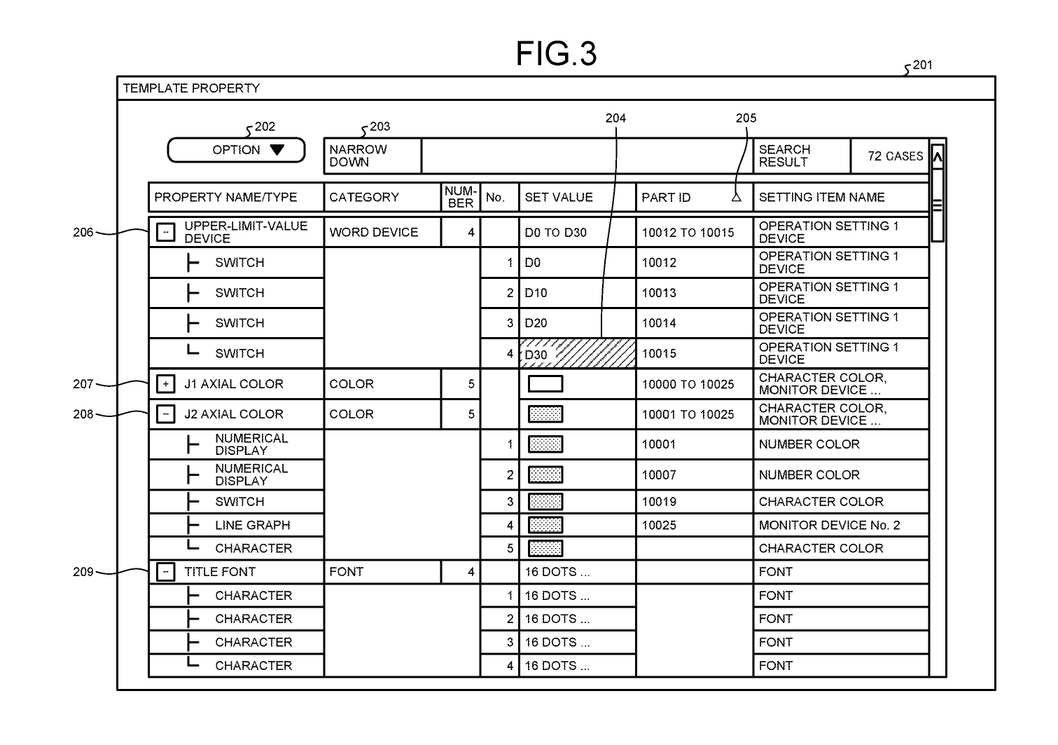

FIG. 3 is an example of a property window of the registered template. The screen creation system can display the setting items registered to the template in a property window 201 on the GUI as a list. The display of a list of the setting items includes at least one of an ID and a name of each part. The user can confirm which of the parts is constituted by each of the setting items displayed in the property window 201 from the ID or the name of the part.

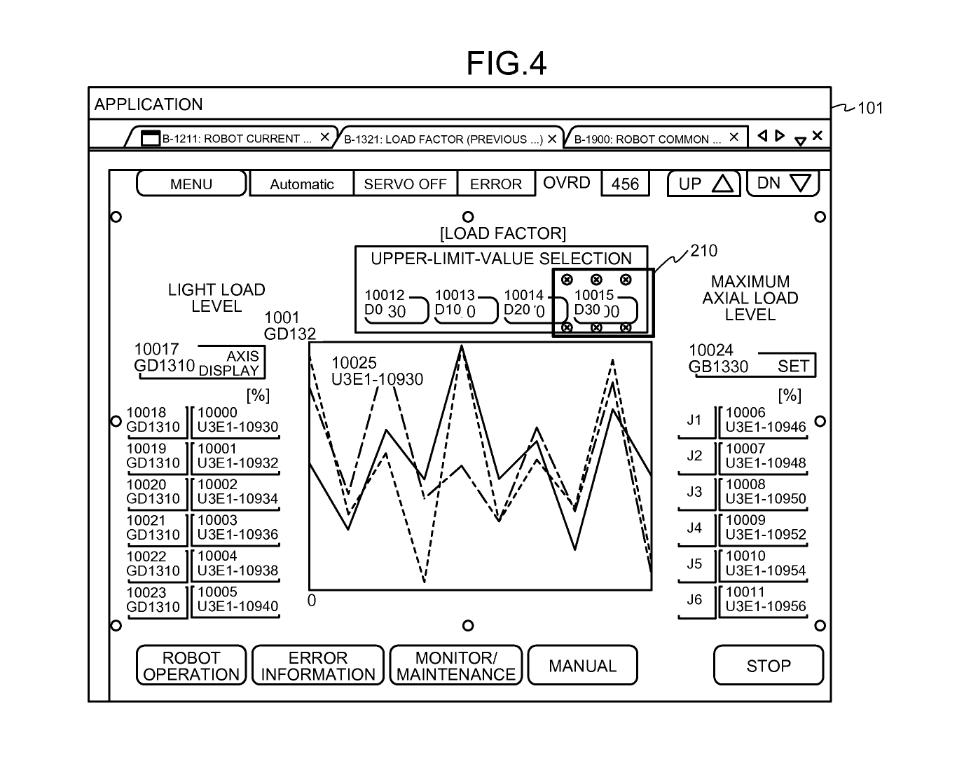

In conjunction with selection of one of the setting items on the display of the list in the property window 201, the screen creation system highlights the part corresponding to the selected setting item on the screen 101. For example, when the user clicks on a cell 204 of a set value “D30” of a certain setting item in the property window 201, a character color and a background color of the cell 204 are inverted. As illustrated in FIG. 4, a part (an upper-limit-value device switch of a part ID 10015) 210 corresponding to the setting item selected by clicking on the cell 204 is highlighted on the screen 101. Highlighting is defined to display, for example, specific marks around a part. Any arbitrary mode can be adopted as long as a specific part can easily be recognized visually by the highlighting.

By highlighting a part on the screen 101, the user can confirm the part to be edited such as one the set value of which is to be changed or the like on the GUI, thus erroneous editing of different unintended part by the user can be suppressed.

In the property window 201, a narrowing-condition entry field 203 is displayed as a means of narrowing down the setting items registered to the template. By entering a character string into the narrowing-condition entry field 203, the screen creation system can display only lines of the properties including the input character string.

Furthermore, when a cell 205 displayed as “part ID” is clicked, the screen creation system sorts out the setting items in an ascending order of the part ID. The cell 205 is defined as a means for changing an alignment sequence of the setting items displayed as a list. By changing the display and the alignment sequence due to narrowing down the setting items, the user can efficiently search and confirm desired setting items from the displayed list.

In the property window 201, among the “property name/type” field, to cells 206, 207, 208, and 209 having names of the grouped setting items, arbitrary names can be set. In the example illustrated in FIG. 3, “upper-limit-value device” to cell, “J1 axial color” to cell 207, “J2 axial color” to cell 208, and “title font” to cell 209 are set as the names of the grouped setting items.

The grouped setting items are hierarchically displayed in the property window 201. Hierarchical buttons are provided in the cells 206, 207, 208, and 209, respectively, for switching between collapse and expansion of hierarchical display.

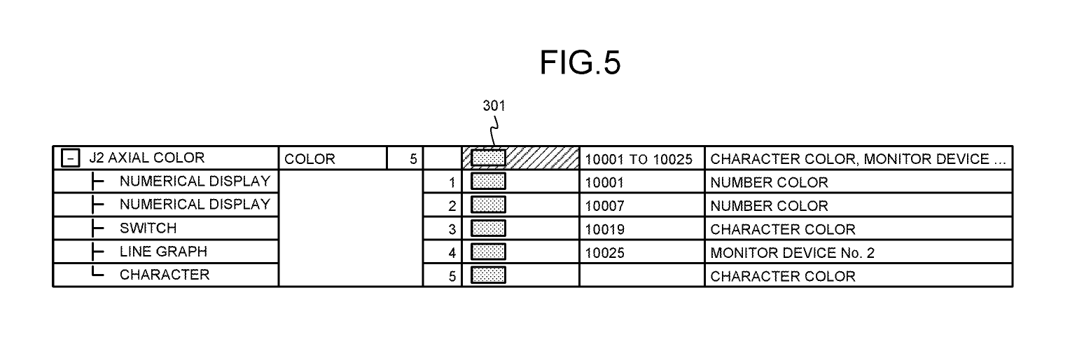

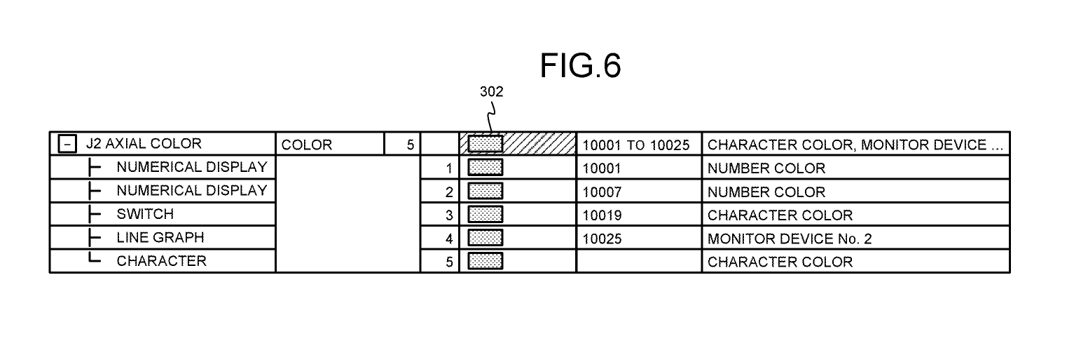

FIG. 5 to FIG. 9 are explanatory diagrams for changing the set values in the property window 201. FIG. 5 and FIG. 6 are explanatory diagrams for changing the set values by batch conversion in a case where a same set value is set to the grouped setting items. As illustrated in FIG. 5, for example, it is assumed that a same color, red for example, is set as the set value to the setting items in a “J2 axial color” group. A red colored rectangle 301 is displayed in a set value cell of each of the setting items. A set value cell in a line of a name of the group represents a set value of the entire group. In this example, the red colored rectangle 301 is displayed as the color setting to each of the setting items.

In a case of changing the color setting to each of the setting items in the “J2 axial color” group from red to gray in this state by batch conversion, the display of the cell for displaying the set value of the entire group is switched to a gray colored rectangle 302 as illustrated in FIG. 6. In response to this, the display of the cell of each of the setting items is automatically switched to the gray colored rectangle 302, and the color setting to each of the setting items in the group is changed from red to gray.

In the examples illustrated in FIG. 5 and FIG. 6, the set values can be changed to a common set value by the batch conversion for the group to which the same set value is set. The cell for displaying the set value of the entire group is defined as a means for changing the set values respectively set to the grouped setting items by batch conversion.

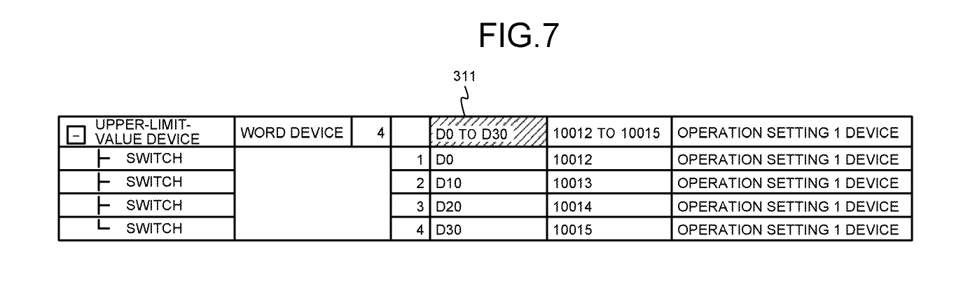

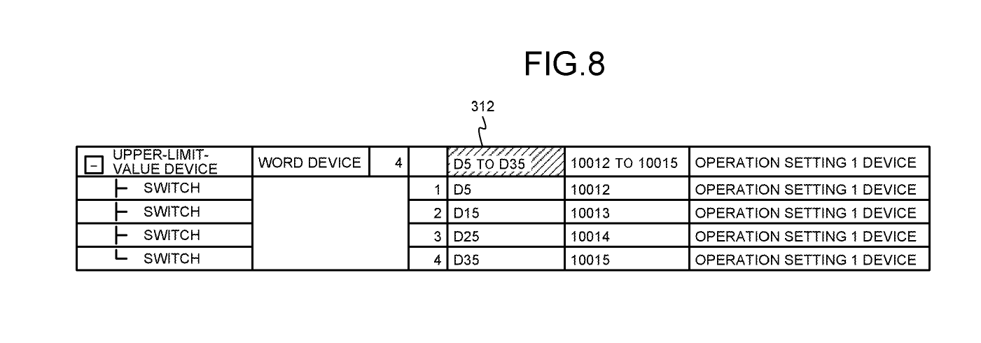

FIG. 7 and FIG. 8 are explanatory diagrams for changing the set values by batch conversion in a case of holding regularity of set values. As illustrated in FIG. 7, for example, it is assumed that device values “D0”, “D10”, “D20”, and “D30” are set as the set values to the setting items in an “upper-limit-value device” group, respectively. A character string 311 of a range “D0 to D30” of the device values set to the respective setting items in the group is indicated in a set value cell in a line of a name of the group.

In a case of changing the device values set to the respective setting items in the “upper-limit-value device” group from Dn to D(n+5) (n is a natural number) in this state by batch conversion, the range of the device values is replaced by a character string 312 of “D5 to D35” as illustrated in FIG. 8. In response to this replacement, the display of the cells of the setting items is automatically switched to “D5”, “D15”, “D25”, and “D35”, and the device values are changed to Dn to D(n+5), respectively.

In the examples illustrated in FIG. 7 and FIG. 8, the batch conversion can be performed while keeping the regularity of the set values. In this example, similarly to the examples illustrated in FIG. 5 and FIG. 6, the cell for displaying the set value of the entire group is defined as a means for changing the set values set to the setting items by batch conversion.

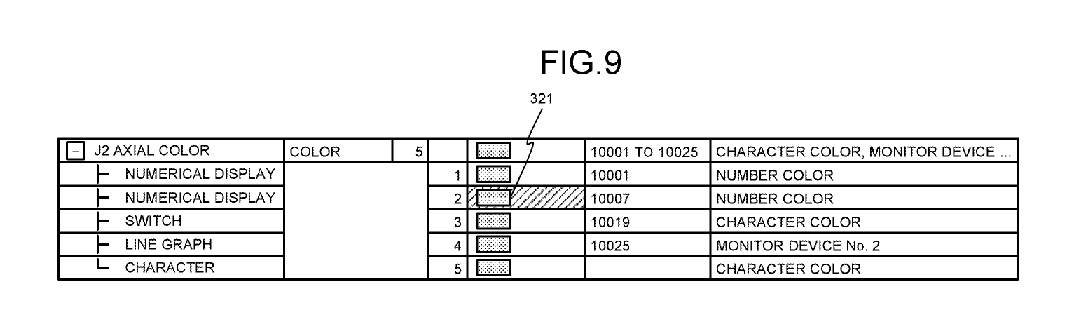

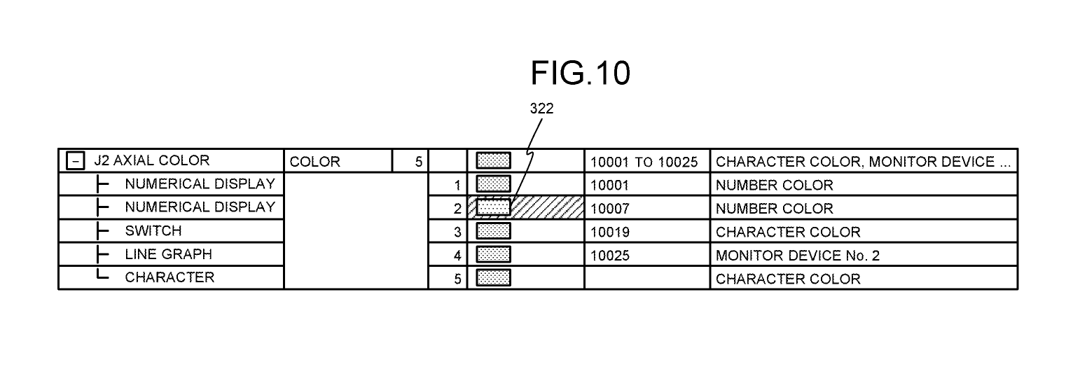

It is assumed that the set values set to the setting items can be changed individually, regardless of whether the setting items have been grouped. In a case where a same color, red for example, is set as the set value to each of the setting items in the “J2 axial color” group as illustrated in FIG. 9, for example, a red rectangle 321 of a predetermined setting item is switched to a gray rectangle 322 as illustrated in FIG. 10. The color setting is thereby changed from red to gray only for the predetermined setting item in the group. Furthermore, in response to generation of a difference in the set value among the setting items in the group, a cell for displaying the set value of the entire group becomes blank. In this way, the screen creation system can change the set value of an arbitrary setting item.

The screen creation system accepts deletion of the setting items registered as the template and addition of the setting items to be registered to the template on the list displayed in the property window 201. The user selects a property edit by, for example, an option key 202, a tool bar, a context menu, or a shortcut key in the property window 201, and executes editing for the deletion or the addition of the setting items. It is thereby possible to newly register a setting item group, delete the existing setting item group, and add or delete setting items to or from the existing setting item group by a simple operation.

To add a new part to a created template, the user selects an existing template and a desired part and instructs the addition of the part by the tool bar, the context menu, the shortcut key, or the like. To delete a part from the created template, the user instructs the deletion of the part from the existing template by the tool bar, the context menu, the shortcut key, or the like. It is thereby possible to add or delete parts based on the existing template by a simple operation.

To deregister the created template, the user selects one of existing templates and instructs deregistration of the selected template by the tool bar, the context menu, the shortcut key, or the like.

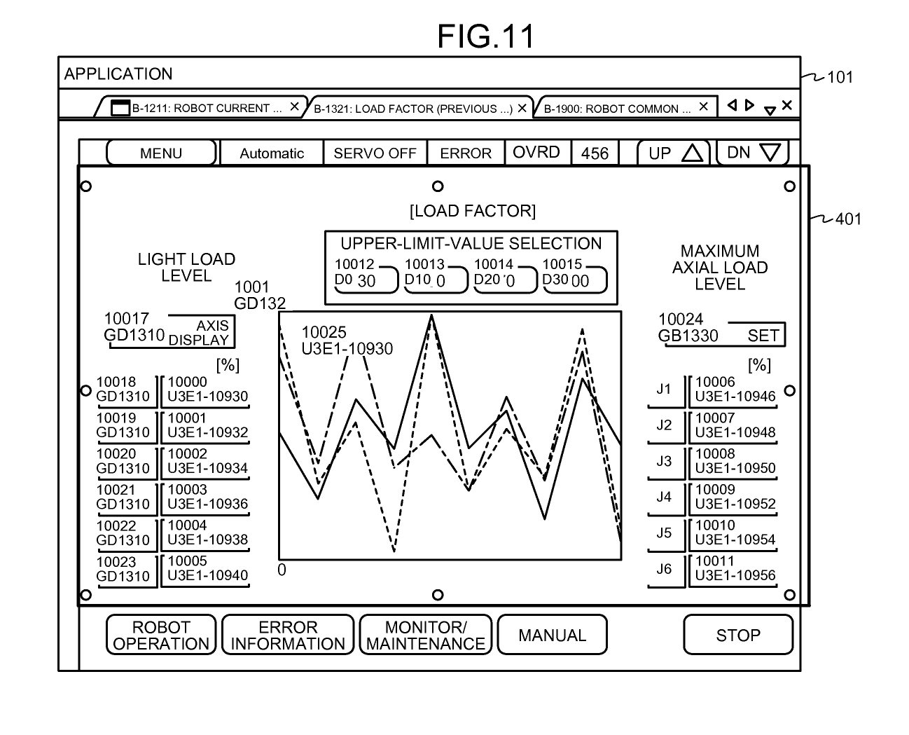

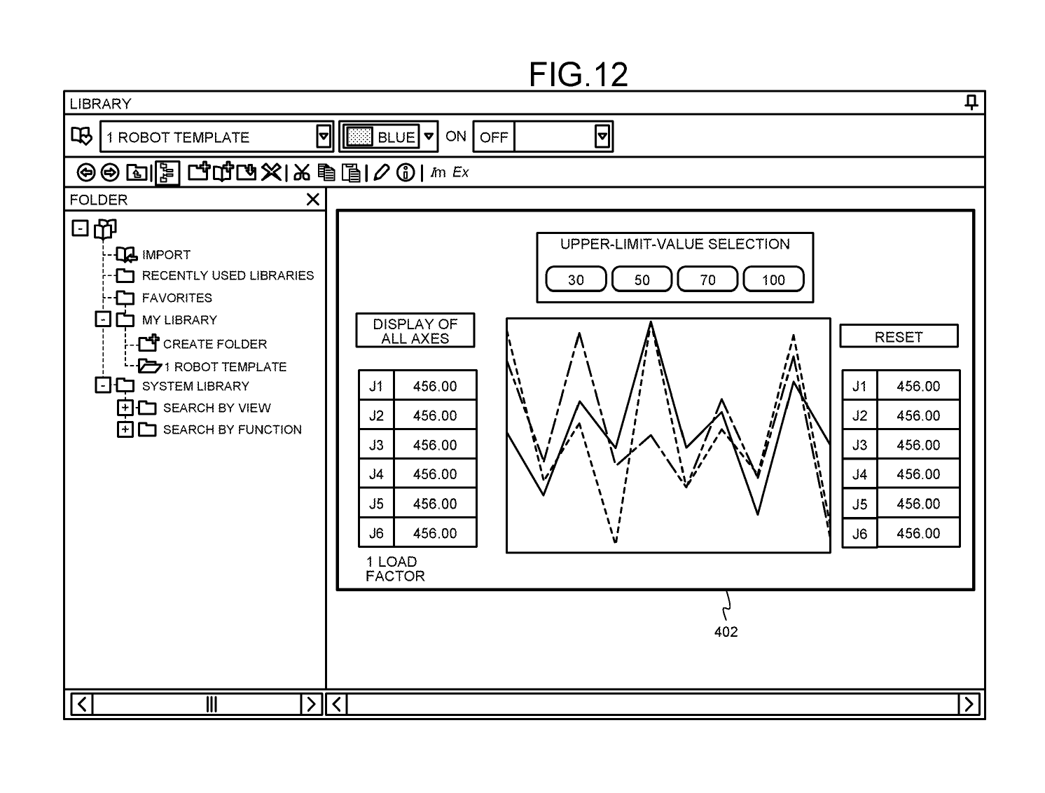

FIG. 11 and FIG. 12 are explanatory diagrams for the registration of a template to a library. The user drags and drops a template 401 on the GUI of the screen creation system illustrated in FIG. 11 onto a library window illustrated in FIG. 12, thereby executing the registration of the template to the library.

A template 402 registered to the library can be read out from the library window onto the GUI of the screen creation system by drag and drop and can be used by the screen creation system. It is thereby possible to reuse the existing template by a simple operation.

In a case of editing the template 402 registered to the library, an editing content is reflected in the originally registered template 401 on the screen creation system. It is thereby possible to keep identity between the template 402 registered to the library and the template 401 on the screen creation system.

### REFERENCE SIGNS LIST

101 screen
102 property registration window
201 property window
202 option key
203 narrowing-condition entry field
401, 402 template

1. A screen creation system for a programmable display for creating a screen to be displayed on the programmable display by arranging parts on a graphical user interface, comprising:
a unit that accepts selection of setting items constituting each of a plurality of parts so as to register the parts and the setting items as a template on the graphical user interface creating a screen to be displayed at a graphical user interface of a programmable display, comprising:
a registering unit that registers setting items that are set as a template regarding a configuration of a plurality of parts that makes the screen as elements that constitute the screen, wherein
when a new registration of the template is instructed regarding parts that are selected from the graphical user interface, the registering unit for registering the template is configured to:
group and present setting items for each one of the selected parts based on properties thereof; and
accept selection of the setting items to be included in the template.

2. The screen creation system for a programmable display according to claim 1, wherein
the setting items registered to the template are displayed as a state being grouped and as a list on the graphical user interface.

3. The screen creation system for a programmable display according to claim 2, further comprising:
a unit that changes an alignment sequence of the setting items displayed as a list.

4. The screen creation system for a programmable display according to claim 2 or 3, further comprising:
a unit that executes narrowing down of the setting items registered to the template.

5. The screen creation system for a programmable display according to claim 2, wherein
display of the list of the setting items includes display of at least one of an ID and a name of each of the parts.

6. The screen creation system for a programmable display according to claim 2, wherein, in the screen that is displayed on the graphical user interface based on the setting items registered in the template, in conjunction with selection of one of the setting items on the display of the list, one of the parts corresponding to the selected setting item is highlighted.

7. The screen creation system for a programmable display according to claim 2, wherein
deletion of the setting items registered to the template and addition of the setting items to be registered to the template are accepted on the display of the list.

8. (canceled)

9. The screen creation system for a programmable display according to claim 2, further comprising at least one of:
a first unit that changes each set values, for groups to which a same set value is set to the setting items, to a common set value by batch conversion; and
a second unit that changes each set values, for groups to which a set value holding regularity is set to the setting items, by batch conversion in a state holding the regularity.

10. The screen creation system for a programmable display according to claim 1, wherein
registration of the template to a library and reading of the template registered to the library are accepted on the graphical user interface.

11. The screen creation system according to claim 10, wherein
the template registered to the library is edited, thereby reflecting an editing content in the template originally registered on the screen creation system.
